(19) United States
(12) Patent Application Publication
(10) Pub. No.: US 2015/0375978 A1
(43) Pub. Date: Dec. 31, 2015

(54) FORK ASSEMBLY FOR LIFTING MACHINES WITH INTERLOCKING TINES

(71) Applicant: Caterpillar Inc., Peoria, IL (US)

(72) Inventors: Chetan V. Dahiwal, Chennal (IN); Gopalakrishnan Kanniappan, Thiruvannamalai (IN); Venkatesh Madeshi, Sironcha (IN); Gregory A. Seljestad, Wamego, KS (US); Anuop Udayakumar, Chennai (IN)

(73) Assignee: Caterpillar Inc., Peoria, IL (US)

(21) Appl. No.: 14/846,824

(22) Filed: Sep. 7, 2015

(51) Int. Cl. B66F 9/12

(52) U.S. Cl. CPC B66F 9/12

(57) ABSTRACT

A fork assembly for a lifting machine is provided. The fork assembly includes a fork base and a tine member. A first end of the fork base is attachable to the movable frame portion. A second end of the fork base extends outwardly from the first end. The fork base defines a lift surface, a first side surface, and a second side surface. The tine member defines a top portion, a first side portion, a second side portion, and a bottom portion. The bottom portion of the tine member defines a recess with a first engagement wall, a second engagement wall, and a third engagement wall. The tine member attains an interlocked position with the fork base, when the fork base is disposed within the recess of the tine member.

### TECHNICAL FIELD

The present disclosure relates to fork assemblies in lifting machines. More particularly, the present disclosure relates to fork assemblies with serviceable and interlockable tines.

### BACKGROUND

Machines, such as forklifts, wheel loaders, and backhoe loaders, are typically used in work environments to lift and transport loads for short distances. For such short movement applications, lifting machines may have a fork assembly to lift, move, and stack pallets, blocks, and other goods, at a worksite. Typically, the fork assembly includes a pair of tines attached permanently to a mounting frame which is attached to the machine. For example, in a stone quarry, the fork assembly is often attached to the machine to lift and transport stone blocks in and around the quarry site.

During a loading process, the tines are used to cover portions of the fork assembly that engage with the load. However, the tines generally scrape against a floor surface when goods are lifted during an engagement. This results in wear on a bottom face and tips of the tines. Wear of the tips results in reduction of the overall length of the tines. If a reduced tine is left without appropriate service, probability of instability during the lift and transport of the goods increases, as enough base support is not provided to the goods. Also, the tine tips can become sharp, which can cause damage to the integrity of the goods and may be unfavorable for on-site personnel. Therefore, due to these safety concerns replacement of these tines becomes unavoidable. Hence, the damaged and reduced tines are removed and replaced with a new set of tines. The new set of tines is welded to the mounting frame, which can be a tedious process. The replacement process involves cutting and separating the worn-out tines from the mounting frame and welding a new pair of tines to the mounting frame. This process is labor-intensive and time-consuming, which may lead to inefficiency in the operation. In addition, such a service incurs cost, a burden of effort, loss of productive time and compromise on structures due to reworking.

United States Patent Publication 2007/01165 relates to a protective tip for a tine of a forklift. The protective tip includes a body that defines a recess to accommodate the end of the tine. The body is substantially U-shaped to receive the end of the tine. The body is secured to the tine by a pair of grub screws, which extend through the apertures defined in the arms of the tip. This ensures that the protective tip endures damage and wears, instead of the tine. However, if the lower portion and/or upper portion of the body, defined beyond the protective tip is damaged, the tine may need to be replaced. Thus, the protective tip suffers from inadequate impartation of protection to the lower portion of the tine, which may be prone to potential damages. Furthermore, this solution makes the tip of the tines bulkier making them unsuitable for a stone block handling operation, which requires the tines to retain their sharp edges to penetrate through the thin gaps between the heavy stone blocks.

The present disclosure seeks to address one or more of the problems stated above.

### SUMMARY OF THE INVENTION

Various aspects of the present disclosure describe a fork assembly for a lifting machine. The fork assembly is mountable to a movable frame portion of the lifting machine. The fork assembly includes a fork base and a tine member. The fork base includes a first end and a second end. The first end of the fork base is attachable to the movable frame portion of the lifting machine. The second end of the fork base extends outwardly from the first end of the fork base. The fork base defines a lift surface, a first side surface, and a second side surface. The tine member defines a top portion, a first side portion, a second side portion, and a bottom portion. The bottom portion of the tine member defines a recess, which includes a first engagement wall, a second engagement wall, and a third engagement wall. The tine member is removably attachable to the fork base and defines an interlocked position with the fork base. This is done in response to the disposition of the fork base within the recess of the tine member and at least one fastener extended through the tine and being engaged with the fork base. Also, the tine member is in the interlocked position with the fork base in response to the lift surface of the fork base, which is engaged with the first engagement wall of the tine member, the first side surface of the fork base, which is engaged with the second engagement wall of the tine member, and the second side surface of the fork base being engaged with the third engagement wall of the tine member.

### BRIEF DESCRIPTION OF THE DRAWINGS

FIG. 1 is a perspective view of a lifting machine with a fork assembly, in accordance with the concepts of the present disclosure;

FIG. 2 is a perspective view of the fork assembly of FIG. 1, with a disassembled tine member, in accordance with the concepts of the present disclosure;

FIG. 3 is a bottom perspective view of the fork assembly of FIG. 2 with the disassembled tine member, depicting a complementation between the fork assembly and the tine member, in accordance with the concepts of the present disclosure; and

FIG. 4 is a perspective view of the fork assembly of FIG. 2 assembled with the tine member, in accordance with the concepts of the present disclosure.

### DETAILED DESCRIPTION

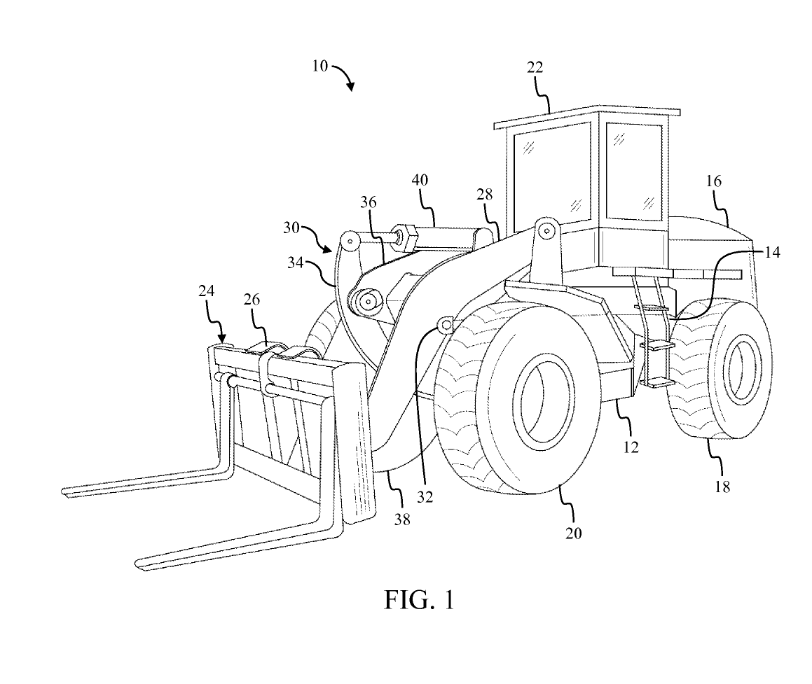

FIG. 1 illustrates an embodiment of a wheel loader machine 10. However, an application of the present disclosure is also envisioned for other conventionally available and applicable lifting machines, such as forklifts, block handlers, and the like. An extension of the aspects of the present disclosure is also contemplated for environments that apply structures and configurations similar to what has been disclosed here.

The wheel loader machine 10 includes a front-end frame 12, a rear-end frame 14, a body portion 16, rear wheels 18, front wheels 20, a cab 22, a fork assembly 24, and a coupler 26. The rear-end frame 14 supports the body portion 16, which houses an engine (not shown). The engine (not shown) drives the rear wheels 18. The body portion 16 is equipped with the cab 22 for an operator. The wheel loader machine 10 is hereafter referred to as the machine 10.

The front-end frame 12 is supported on the front wheels 20 that are turned by steering controls (not shown) housed inside the cab 22. The front-end frame 12 may be machine chassis having one of a ladder frame, monocoque, body on frame, or a semi- monocoque construction. The front-end frame 12 is equipped with a provision to attach a pair of lift arms 28 and a Z-bar linkage 30.

One end of each lift arm 28 is pivotally connected to the front-end frame 12, while the other end of the lift arm 28 is pivotally connected to the coupler 26. The lift arms 28 are rotatable about the point of connection defined at the front-end frame 12. This rotation is controlled by associated lift cylinders 32 that are pivotally coupled to the rear-end frame 14 and the lift arms 28. The lift cylinders 32 are extended to raise the lift arms 28 and retracted to lower the lift arms 28.

The lift arms 28 are provided with an implement in the form of a fork assembly 24. The coupler 26 connects the fork assembly 24 with the lift arms 28. The fork assembly 24 and the coupler 26 may be configured to secure attachment of the fork assembly 24 before the operation, and for release of the fork assembly 24 and substitution of another implement, such as a bucket (not shown). Although the coupler 26 and fork assembly 24 are illustrated and described as separate connectable components, one skilled in the art will understand that fork assemblies may be configured unitarily with the coupler.

The rotation of the coupler 26 and the attached fork assembly 24 is controlled by the Z-bar linkage 30 of the front-end frame 12. The Z-bar linkage 30 includes a tilt lever 34 pivotally connected to a tilt lever support 36 mounted on the lift arms 28 such that the tilt lever support 36 moves with the lift arms 28. At one end of the tilt lever 34, a tilt link 38 is connected. The tilt link 38 has one end pivotally connected to the end of the tilt lever 34, and the opposite end pivotally connected to the coupler 26. A tilt cylinder 40 couples the opposite end of the tilt lever 34 to the front-end frame 12 with pivotal connections at either end. For a given position of the lift arms 28, the coupler 26, and the fork assembly 24 are rotated toward the racked position by extension of the tilt cylinder 40, and rotated in the opposite direction toward the dump position by retraction of the tilt cylinder 40. Effectively, a movement of the lift arms 28 corresponds to a tilt of the fork assembly 24, relative to the tilt link 38.

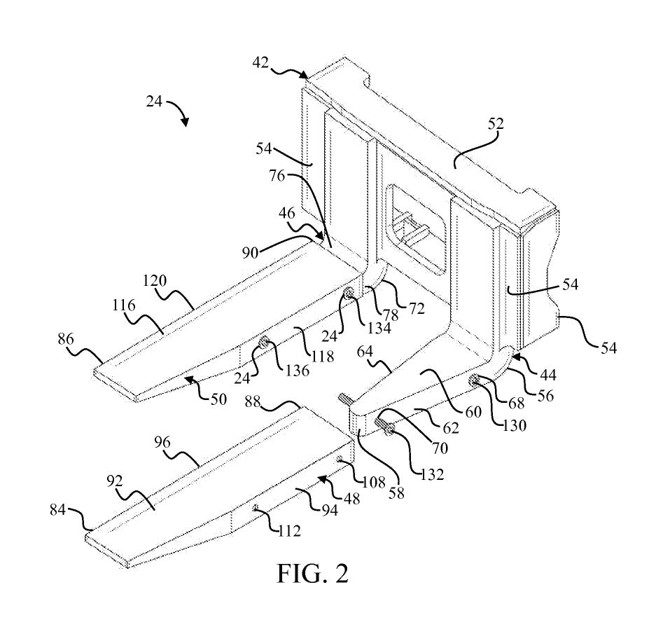

Referring to FIG. 2, there is shown the fork assembly 24 in a disassembled form. The fork assembly 24 includes a movable frame portion 42, a first fork base 44, a second fork base 46, a first tine member 48, and a second tine member 50. The first tine member 48 is shown in a potential assembly position from the first fork base 44. The movable frame portion 42 is in engagement with the coupler 26. The movable frame portion 42 includes a frame top portion 52 and a frame base portion 54. The frame base portion 54 includes the first fork base 44 and the second fork base 46.

The first fork base 44 and the second fork base 46 are integrally attached to the frame base portion 54 of the movable frame portion 42. The first fork base 44 and the second fork base 46 are attached perpendicular, relative to the movable frame portion 42. The first fork base 44 and the second fork base 46 are spaced apart from each other. In alternative embodiments, there may be one or more than two fork bases, in the fork assembly of the lifting machines.

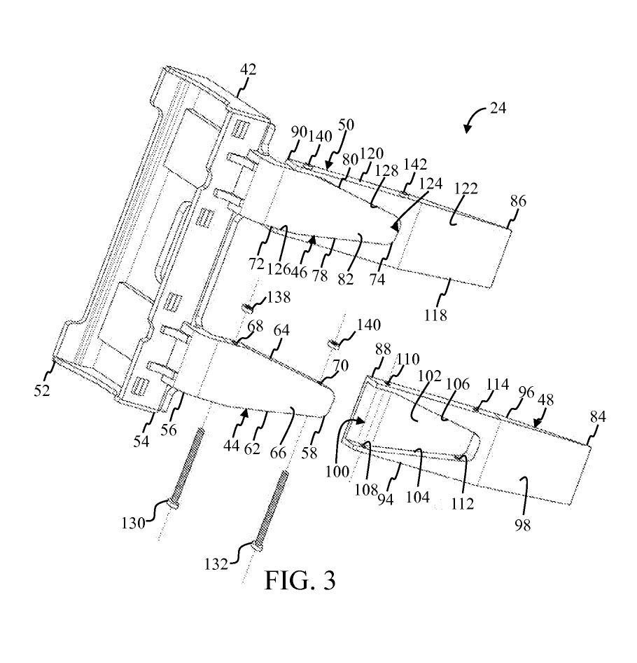

Referring to FIGS. 2 and 3, the first fork base 44 includes a first end 56 and second end 58. The first end 56 is attached to the frame base portion 54 of the movable frame portion 42. The second end 58 extends outward from the first end 56, in a generally perpendicular direction away from the movable frame portion 42. The first fork base 44 also includes a lift surface 60, a first side surface 62, a second side surface 64, and a bottom surface 66, which are defined between the first end 56 and the second end 58. The lift surface 60 is defined as a flat top surface of the first fork base 44. The lift surface 60 comes in indirect contact with a load during a lift operation, and thus is sufficiently strengthened. The first side surface 62 and the second side surface 64 are attached to both sides of the lift surface 60. In addition, the first side surface 62 and the second side surface 64 are formed substantially perpendicularly to the bottom surface 66. The bottom surface 66 is a substantially flat portion of the first fork base 44. Also, a first through-hole 68 and a second through-hole 70 are defined between the first side surface 62 and the second side surface 64 of the first fork base 44. The first through-hole 68 is disposed proximal to the first end 56. The second through-hole 70 is disposed proximal to the second end 58.

Similarly, the second fork base 46 includes a first end 72 and a second end 74 (FIG. 3). The first end 72 is attached to the frame base portion 54 of the movable frame portion 42. The second end 74 extends away from the movable frame portion 42, parallel to the first fork base 44. The second fork base 46 also includes a lift surface 76, a first side surface 78, a second side surface 80, and a bottom surface 82, which are defined between the first end 72 and the second end 74. A first through-hole (not shown) and a second through hole (not shown) are defined between the first side surface 78 and the second side surface 80 of the second fork base 46. The first through-hole (not shown) is disposed proximal to the first end 72. The second through-hole (not shown) is disposed proximal to the second end 74. The structure and function of the second fork base 46 is similar to that of the first fork base 44.

The first tine member 48 and the second tine member 50 are removably attachable to the first fork base 44 and the second fork base 46, respectively. The first tine member 48 and the second tine member 50 include tip portions 84, 86, and end portions 88, 90. The first tine member 48 includes a top portion 92, a first side portion 94, a second side portion 96, and a bottom portion 98, which are defined between the tip portion 84 and the end portion 88. The top portion 92 is flat in shape and is attached to the first side portion 94 and the second side portion 96. The first side portion 94 and the second side portion 96 are attached to the bottom portion 98. The bottom portion 98 of the first tine member 48 defines a recess 100 (FIG. 3), towards the end portion 88 of the first tine member 48. The recess 100 extends from the end portion 88 of the first tine member 48 to nearly a middle of the first tine member 48.

The recess 100 of the bottom portion 98 includes a first engagement wall 102, a second engagement wall 104, and a third engagement wall 106. The first engagement wall 102 extends along the top portion 92. The second engagement wall 104 and the third engagement wall 106, respectively, extend along the first side portion 94 and the second side portion 96 of the first tine member 48.

In addition, the first tine member 48 includes a first hole 108, a second hole 110, a third hole 112, and a fourth hole 114, which coincide with the recess 100. The first hole 108 and the second hole 110 are disposed near the end portion 88 of the first tine member 48. The third hole 112 and the fourth hole 114 are disposed distal from the end portion 88. The first hole 108 and the third hole 112 are defined between the first side portion 94 and the second engagement wall 104. The second hole 110 and the fourth hole 114 are defined between the second side portion 96 and the third engagement wall 106. The first hole 108 and the second hole 110 of the first tine member 48 are arranged to coincide and align with the first through-hole 68 of the first fork base 44. The third hole 112 and the fourth hole 114 of the first tine member 48 are arranged to coincide and align with the second through-hole 70 of the first fork base 44.

The second tine member 50 includes a top portion 116, a first side portion 118, a second side portion 120, and a bottom portion 122, which are defined between the tip portion 86 and the end portion 88. The bottom portion 122 of the second tine member 50 defines a recess 124, which extends from the end portion 90 of the first tine member 48. The recess 124 of the bottom portion 122 includes a first engagement wall (not shown), a second engagement wall 126, and a third engagement wall 128, which are structurally similar to that of the first tine member 48. The second tine member 50 includes four holes (not shown), which are disposed near the recess 124. The holes (not shown) are arranged in a manner to coincide and align with the first through-hole (not shown) and the second through-hole (not shown). The structure and function of the second tine member 50 is similar to that of the first tine member 48.

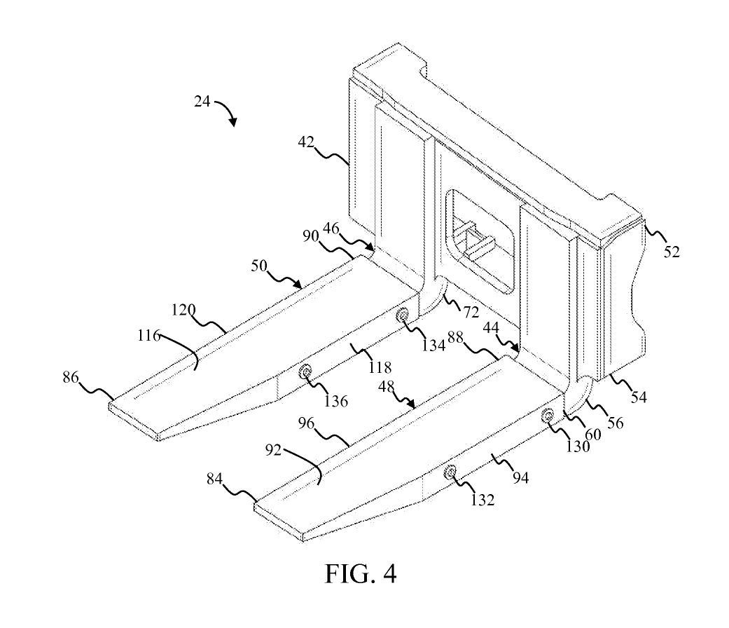

Referring to FIG. 4, there is shown an assembled position of the fork assembly 24. For the assembled position, the first tine member 48 and the second tine member 50 are brought to an interlocked position with the first fork base 44 and the second fork base 46. The first fork base 44 and the second fork base 46 are disposed within the recesses 100 and 124 of the first tine member 48 and the second tine member 50, respectively. In this position, the lift surfaces 60 and 76 of the fork bases 44 and 46 are engaged with the first engagement walls 102 of the tine members 48 and 50. Further, the first side surfaces 62 and 78 of the fork bases 44 and 46 are engaged with the second engagement walls 104 and 126 of the tine members 48 and 50. The second side surfaces 64 and 80 of the fork bases 44 and 46 are engaged with the third engagement walls 106 and 128 of the tine members 48 and 50.

The tine members 48 and 50 and the fork bases 44 and 46 are respectively maintained in the interlocked position, via fasteners 130 and 132, and 134 and 136, which extend through the tine members 48 and 50 and are engaged with the fork bases 44 and 46. The fastener 130 is inserted such that the fastener 130 passes serially through the first hole 108, the first through-hole 68, and the second hole 110. The fastener 130 is secured at the third engagement wall 106, via a nut 138. Similarly, the fastener 132 is inserted such that the fastener 132 passes serially through the third hole 112, the second through-hole 70, and the fourth hole 114. The fastener 132 is secured at the third engagement wall 106, via a nut 140. The fasteners 134 and 136 area inserted in similar fashion and are secured at the third engagement wall 128, via nuts 142 and 144.

### INDUSTRIAL APPLICABILITY

In operation, the tine members 48 and 50 are removably attachable to the fork bases 44 and 46. For attachment of the tine members 48 and 50 to the fork bases 44 and 46, the fork bases 44 and 46 are inserted in the recesses 100 and 124 defined in the tine members 48 and 50. Upon insertion of the fork bases 44 and 46 in the recesses 100 and 124, the top portions of the tine members 48 and 50 completely cover the fork bases 44 and 46, by extending up to the first ends of the fork bases 44 and 46. This is referred to as the interlocked position of the tine members 48 and 50 with the fork bases 44 and 46. In the interlocked position, the top portions of the fork bases 44 and 46 are in contact and engagement with the first engagement walls 102 of the tine members 48 and 50. Also, the first side surfaces 62 and 78 and the second side surfaces 64 and 80 of the fork bases 44 and 46 are in engagement with the second engagement walls 104 and 126 and the third engagement walls 106 and 128 of the tine members 48 and 50. The first fork base 44 is held in the interlocked position with the first tine member 48, with insertion of the fasteners 130 and 132. The second fork base 46 is held in the interlocked position with the second tine member 50, with insertion of the fasteners 134 and 136.

The disclosed fork assembly 24 provides removably attachable tine members 48 and 50 that protect the fork bases 44 and 46 by accommodation of the fork bases 44 and 46. Also, the first tine member 48 and the second tine member 50 are symmetrical and can be interchangeably attached to the first fork base 44 and the second fork base 46. This mitigates wear of the top portions of the fork bases 44 and 46. In addition, the height of the recesses 100 and 124 is nearly equal to the thickness of the fork bases 44 and 46, which protects the bottom portions of the fork bases 44 and 46. Since, the tine members 48 and 50 extend to the first ends of the fork bases 44 and 46, this provides increased lifting support to the fork bases 44 and 46 accommodated in the recesses 100 and 124. Also, in case of wear of the tine members 48 and 50, only the tine members 48 and 50 are required to be replaced or repaired. Hence, operation costs, effort, and machine downtime, is reduced.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to one skilled in the art. It is not desired to limit the disclosure to the exact construction and operation illustrated and described, and, accordingly, all suitable modifications and equivalents may be resorted to that fall within the scope of the disclosure.

What is claimed is:

1. A fork assembly for a lifting machine, the fork assembly being mountable to a movable frame portion of the lifting machine, the fork assembly comprising:
a fork base having a first end and a second end, the first end of the fork base being attachable to the movable frame portion of the lifting machine, the second end of the fork base extending outwardly from the first end of the fork base, the fork base defining a lift surface, a first side surface, and a second side surface;
a tine member defining a top portion, a first side portion, a second side portion, and a bottom portion, the bottom portion of the tine member defining a recess, the recess of the bottom portion of the tine having a first engagement wall, a second engagement wall, and a third engagement wall,
wherein the tine member being removably attachable to the fork base and defining an interlocked position with the fork base in response to:
the fork base being disposed within the recess of the tine member and at least one fastener extended through the tine and being engaged with the fork base, and
the lift surface of the fork base being engaged with the first engagement wall of the tine member, the first side surface of the fork base being engaged with the second engagement wall of the tine member, and the second side surface of the fork base being engaged with the third engagement wall of the tine member.
